(19) United States
(12) Patent Application Publication
(10) Pub. No.: US 2007/0073005 A1
(43) Pub. Date: Mar. 29, 2007

(54) Anionic electrodeposition paint

(76) Inventors: Hideki Iijima, Chigasaki-shi (JP); Koji Kamikado, Yokohama-shi (JP); Masaharu Shimoda, Hiratsuka-shi (JP); Shigeo Nishiguchi, Hiratsuka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/524,250

(22) Filed: Sep. 21, 2006

(30) Foreign Application Priority Data
Sep. 22, 2005 (JP) 2005-276700

(51) Int. Cl. C08G 63/91

(52) U.S. Cl. 525/430

(57) ABSTRACT

This invention provides an anionic electrodeposition paint comprising an epoxy resin-modified polyester resin which is obtained by reacting carboxyl-containing polyester resin with epoxy resin having at least one epoxy group per molecule, and further optionally with at least one active hydrogen compound selected from monophenols, aliphatic monocarboxylic acids and monoalcohols, said paint being capable of forming coating film excelling in coating film performance such as corrosion resistance, weatherability impact resistance, finished appearance, low temperature-curability, watermark resistance, etc. and coating workability such as secondary sagging and foaming resistance.

### TECHNICAL FIELD

This invention relates to anionic electrodeposition paint which forms coating film excelling in corrosion resistance, weatherability, impact resistance, finished appearance, low temperature-curability, water mark resistance, coating workability and so on.

### BACKGROUND ART

Anionic electrodeposition paint is used in field of broad range including industrial parts and automobile parts, and is required to be capable of producing coated articles with excellent coating performance such as corrosion resistance, weatherability, impact resistance, finished appearance, low temperature-curability and so on, at low costs.

For example, JP Sho 62(1987)-87282A discloses anionic electrodeposition paint in which carboxyl-containing resins such as maleinated resin formed by addition of maleic anhydride to drying oil (linseed oil, dehydrated castor oil, tung oil or the like); maleinated polybutadiene resin formed by adding maleic anhydride to polybutadiene (1,2 type, 1,4 type and the like); resin formed by adding maleic anhydride to an ester of epoxy resin and unsaturated fatty acid; resin formed by adding polybasic acid to high molecular weight polyhydric alcohol; carboxyl-containing polyester resin; carboxyl-containing acrylic resin and the like. However, this anionic electrodeposition paint has a defect that coating film formed therefrom has insufficient corrosion resistance.

Also JP Hei 10(1998)-147734A discloses an electrodeposition coating composition comprising a low molecular weight polyol having primary hydroxyl groups, which is obtained by reacting epoxy resin having cycloaliphatic moiety with monocarboxylic acid and then reacting the residual hydroxyl groups with ε-caprolactone; a crosslinking agent; and further optionally ionic high molecular weight polyol. However, the electrodeposition coating compositions disclosed in this Official Gazette are unsatisfactory in their coating film performance such as corrosion resistance, low temperature-curability, watermark resistance and the like and in their coating workability such as resistance to secondary sagging and foaming.

JP 2000-186235A discloses anionic, thermosetting electrodeposition coating composition which comprises hydroxyl- and carboxyl-containing resin, crosslinking agent, basic neutralizer and water as the essential components. However, coating film formed by applying the anionic electrodeposition coating composition disclosed in this Official Gazette onto industrial parts or automobile parts is subject to a problem of insufficient corrosion resistance.

### DISCLOSURE OF THE INVENTION

The object of the present invention is to provide anionic electrodeposition paint which is capable of forming coating film excelling in coating film performance such as corrosion resistance, weatherability, impact resistance, finished appearance, low temperature-curability, watermark resistance and so on, and also in coating workability such as secondary sagging and foaming resistance, without using toxic metals such as lead compound or chromium compound.

We have made concentrative studies to now discover that the above object could be accomplished by using, as the base resin component of anionic electrodeposition paint, an epoxy resin-modified polyester resin formed by reacting a carboxyl-containing polyester resin with an epoxy resin having at least one epoxy group per molecule, and optionally further reacting the same with an active hydrogen compound, and have completed the present invention.

Thus, the present invention provides an anionic electrodeposition paint comprising an epoxy resin-modified polyester resin (A1) which is formed by reacting a carboxyl-containing polyester resin (a) with an epoxy resin (b) having at least one epoxy group per molecule.

The invention also provides an anionic electrodeposition paint comprising an epoxy resin-modified polyester resin (A2) which is formed by reacting a carboxyl-containing polyester resin (a) with an epoxy resin (b) having at least one epoxy group per molecule and at least one active hydrogen compound (c) selected from the group consisting of monophenols, aliphatic monocarboxylic acids and monoalcohols.

According to the present invention, anionic electrodeposition paint excelling in coating performance such as corrosion resistance, weatherabilty, impact resistance, finished appearance, low temperature-curability, watermark resistance and so on and also in coating workability such as secondary sugging and foaming resistance, without using harmful compounds such as lead compound or chromium compound.

The reason why the coating film formed of the anionic electrodeposition paint of the present invention excels in corrosion resistance is unclear, but presumably the use of an epoxy resin-modified polyester resin as a base resin component effectively inhibits infiltration of corrosive substances (oxygen, Na ion, Cl ion and the like) through the formed coating film. Furthermore, because the coating film formed of an anionic electrodeposition paint of the present invention excels in coating workability such as watermark resistance or secondary sagging and foaming resistance, use of the anionic electrodeposition paint of the present invention leads to simplification of water washing facilities for coating step, to accomplish step-shortening or energy-saving effect.

### BRIEF DESCRIPTION OF THE DRAWING

FIG. 1 is a schematic drawing of a panel for secondary sagging test. In the drawing, 1 is a chemically treated, cold-rolled steel sheet (0.8 mm×70 mm×150 mm); 2 is a chemically treated, cold-rolled steel sheet (0.8 mm×50 mm×50 mm); and 3 is the water oozed from sagging paint.

### EMBODIMENTS OF THE INVENTION

Hereinafter the invention is explained in further details.

Epoxy Resin-Modified Polyester Resin (A1):

The epoxy resin-modified polyester resin (A1) used in the anionic electrodeposition paint of the present invention is a resin formed by reacting a carboxyl-containing polyester resin (a) with an epoxy resin (b) having at least one epoxy group per molecule.

Polyester Resin (a):

The polyester resin can be obtained through customary esterification reaction of polybasic acid with polyhydric alcohol, e.g., direct esterification process or ester interchange process.

As the polybasic acid, for example, dibasic acid and anhydride thereof, e.g., phthalic anhydride, isophthalic acid, terephthalic acid, hexahydrophthalic acid, hexahydroisophthalic acid, hexahydroterephthalic acid, tetrahydrophthalic acid, methyl-hexahydrophthalic acid, tetrahydrophthalic anhydride, hexahydrophthalic anhydride, succinic acid, fumaric acid, adipic acid, sebacic acid, maleic anhydride and the like; lower alkyl esters of these dibasic acids; and tri- or higher valent polybasic acid and anhydride thereof such as trimellitic acid, hexahydrotrimellitic acid, trimellitic anhydride, methylcyclohexenetricarboxylic acid, pyromellitic anhydride and the like can be named. They may be used either singly or in combination of two or more. Of these, alicyclic polybasic acid having one or two, around 4- to 6-membered alicyclic structures and at least two carboxyl groups per molecule, for example, hexahydrophthalic acid, hexahydroisophthalic acid, hexahydroterephthalic acid, hexahydrotrimellitic acid, tetrahydrophthalic acid, methylhexahydrophthalic acid and their anhydrides are preferred. Where necessary, such polybasic acid can be used concurrently with monobasic acid such as benzoic acid, crotonic acid, p-t-butylbenzoic acid or the like, for, e.g., molecular weight adjustment. Furthermore, oil fatty acid such as coconut oil fatty acid, dehydrated castor oil fatty acid and the like may also be concurrently used.

As the polyhydric alcohol, dihydric alcohol having two hydroxyl groups per molecule and trihydric alcohol having three or more hydroxyl groups per molecule can be used. As examples of the dihydric alcohol, glycols such as ethylene glycol, propylene glycol, diethylene glycol, trimethylene glycol, tetraethylene glycol, triethylene glycol, dipropylene glycol, 2-methyl-1,3-propanediol, 2-butyl-2-ethyl-1,3-propanediol, 1,4-butanediol, 1,3-butanediol, 2,3-butanediol, 1,2-butanediol, 3-methyl-1,2-butanediol, 1,2-pentanediol, 1,5-pentanediol, 1,4-pentanediol, 2,4-pentanediol, 2,3-dimethyltrimethylene glycol, tetramethylene glycol, 3-methyl-4,5-pentanediol, 2,2,4-trimethyl-1,3-pentanediol, 1,6-hexanediol, 1,5-hexanediol, 1,4-hexanediol, 2,5-hexanediol, neopenthyl glycol, hydroxypivalic acid neopentyl glycol ester and the like; polylactonediols formed by adding lactones such as ε-caprolactone to these glycols; polyesterdiols such as bis(hydroxyethyl)terephthalate; alicyclic dihydric alcohols such as cyclohexane-1,4-dimethylol, hydrogenated bisphenol A, spiroglycol, dihydroxymethyl-tricyclodecane and the like can be named. As examples of polyhydric alcohols having at least three hydroxyl groups per molecule, glycerine, trimethylol-propane, trimethylolethane, diglycerine, triglycerine, 1,2,6-hexanetriol, pentaerythritol, dipentaerythritol, tripentaerythritol, sorbitol, mannitol and the like can be named. These can be used either singly or in combination of two or more. Of these, for example, as dihydric alcohol, neopentyl alcohol, 2-methyl-1,3-propanediol, 2-butyl-2-ethyl-1,3-propanediol; and as polyhydric alcohol, trimethylolpropane and glycerine, are preferred.

Introduction of carboxyl group(s) into the polyester resin can be effected, for example, through half esterification reaction of an anhydride of a polybasic acid with a part of the hydroxyl groups of the polyester resin, at temperatures ranging 100-180° C. In that occasion, a minor amount of a high temperature-boiling polar solvent can be added to the reaction system to reduce viscosity of the system, for easier reaction watching and higher production stability. As the high temperature-boiling polar solvent, for example, cyclohexanone can be named.

The carboxyl-containing polyester resin (a) can generally have a number-average molecular weight (note 1) ranging 500-50,000, preferably 800-10,000, inter alia, 1,000-3,000; and an acid value ranging 4-200 mgKOH/g, preferably 20-150 mgKOH/g, inter alia, 40-100 mgKOH/g. The carboxyl-containing polyester resin (a) furthermore preferably contains hydroxyl group(s), and can have a hydroxyl value within a range of 20-800 mgKOH/g, preferably 40-500 mgKOH/g, inter alia, 60-200 mgKOH/g.

(Note 1) Number-Average Molecular Weight:
This can be determined by calculation from a chromatogram on RI refractometer using as the separation columns TSK GEL4000 H_{XL}+G3000 H_{XL}+G2500H_{XL}+G2000H_{XL} (Tosoh Corp.) and as the eluent tetrahydrofuran for GPC, at 40° C. and at a flow rate of 1.0 mL/min.; and calibration curve of polystyrene, following JIS K 0124-83.
   Epoxy Resin (b):

The epoxy resin (b) to be reacted with above-described carboxyl-containing polyester resin (a) has at least one, preferably 1-6, epoxy group(s) per molecule. In respect of corrosion resistance of the coating film, an epoxy resin having at least one epoxy group per molecule, which is obtained by reacting a polyphenol compound with epichlorohydrin is particularly preferred.

As the polyphenol compound useful for making the epoxy resin, for example, bis(4-hydroxyphenyl)-2,2-propane (bis-phenol A), 4,4-dihydroxybenzophenone, bis(4-hydroxyphenyl)methane (bis-phenol F), bis(4-hydroxyphenyl)-1,1-ethane, bis(4-hydroxyphenyl)-1,1-isobutane, bis(4-hydroxy-tert-butylphenyl)-2,2-propane, bis(2-hydroxynaphthyl)-methane, tetra(4-hydroxyphenyl)-1,1,2,2-ethane, 4,4-dihydroxy-diphenylsulfone (bisphenol S), phenol novolak, cresol novolak and the like can be named.

Of the epoxy resins obtained through the reaction of polyphenol compound with epichlorohydrin, those derived from bisphenol A, as represented by the following formula (1):

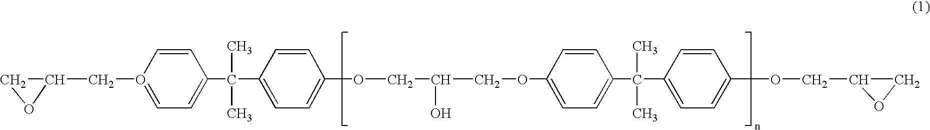

wherein n=0-8,

are preferred.

As such epoxy resins available in the market, for example, those sold by Japan Epoxy Resin Co. under the tradenames of EPICOAT828EL, EPICOAT1002, EPICOAT1004, EPICOAT1007 and so on can be named.

The epoxy resin (b) can generally have an epoxy equivalent within a range of 180-2,500, preferably 200-2,000, inter alia, 400-1,500; and also a number-average molecular weight within a range of generally at least 180, in particular, 400-4,000, inter alia, 800-3,000.

Cyclic ester compound-modified epoxy resin (b1) which is obtained by addition reaction of a cyclic ester compound represented by the following formula (2):

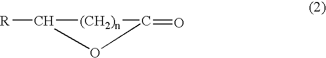

[wherein, R is H or CH₃, and n is 3-6]

to a hydroxyl-containing epoxy resin, can also be used as the epoxy resin (b) having at least one epoxy group per molecule. By the use of such a cyclic ester compound-modified epoxy resin (b1) as the epoxy resin (b), anionic electrodeposition paint capable of forming coating film of excellent finished appearance can be obtained.

As specific examples of such cyclic ester compound, δ-valerolactone, ε-caprolactone, ξ-enalactone, η-caprylolactone, γ-valerolactone, δ-caprolactone, ε-enalactone, ξ-caprylolactone and the like can be named, ε-caprolactone being particularly preferred.

The reaction of hydroxyl-containing epoxy resin with such cyclic ester compound can be conducted by a means known per se, for example, by heating the hydroxyl-containing epoxy resin with the cyclic ester compound at temperatures ranging from about 100° C. to about 250° C. for about an hour—about 15 hours, in the presence of a metal compound as the catalyst, such as a titanium compound, e.g., tetrabutoxytitanium, tetrapropoxytitanium or the like; an organic tin compound such as tin octylate, dibutyltin oxide, dibutyltin laurate or the like; or stannous chloride. The catalyst can be used normally within a range of 0.5-1,000 ppm, based on the combined amount of the hydroxyl-containing epoxy resin and cyclic ester compound.

The use rate of the cyclic ester compound is not strictly limited, while in general terms it is preferred to so adjust it that the content of the component derived from the cyclic ester compound in the formed epoxy resin (b1) becomes 5-40 mass %, preferably 10-35 mass %.

Furthermore, it is also permissible to use, as the epoxy resin (b) having at least one epoxy group per molecule, a plasticizer-modified epoxy resin (b2) which is formed by reacting such an epoxy resin with other plastic component, preferably polyhydric polyol. As polyhydric polyol as the plastic component, for example, diols such as ethylene glycol, propylene glycol, 1,3-butylene glycol, 1,4-butanediol, 1,6-hexanediol, diethylene glycol, dipropylene glycol, cyclohexane-1,4-dimethylol, neopentyl glycol, polypropylene glycol, polyethylene glycol, triethylene glycol, hydrogenated bisphenol A and the like; triols such as glycerine, trimethylolethane, trimethylolpropane and the like; tetrols such as pentaerythritol, α-methylglucoxide and the like; hexols such as sorbitol, dipentaerythritol and the like; and octols such as sucrose and the like can be named.

The plasticizer-modified epoxy resin (b2) can be prepared, for example, through addition reaction of a plastic component as above-described to the epoxy resin by a per se known means. Specifically, for example, it can be prepared by heating the epoxy resin with the plastic component at temperatures ranging from about 100 to about 250° C., for about 1-15 hours, in the presence of a catalyst such as a metal compound, e.g., a titanium compound like tetrabutoxytitanium or tetrapropoxytitanium; an organic tin compound such as tin octylate, dibutyltin oxide or dibutyltin laurate; or stannous chloride. The catalyst can be used normally in an amount within a range of 0.5-1,000 ppm, based on the combined amount of the epoxy resin and the plastic component.

The epoxy resin-modified polyester resin (A1) can be prepared by addition reaction of an epoxy resin (b) having at least one epoxy group per molecule to an above-described carboxyl-containing polyester resin (a) by a means known per se. The reaction ratio of the epoxy resin (b) to the carboxyl-containing polyester resin (a) is not strictly limited, but is adequately variable according to the intended utility of anionic electrodeposition paint. Whereas, in general terms it is convenient to use the carboxyl-containing polyester resin (a) within a range of 50-85 mass %, in particular, 60-80 mass %, inter alia, 65-75 mass %; and the epoxy resin (b), within a range of 15-50 mass %, in particular, 20-40 mass %, inter alia, 25-35 mass %, based on the combined mass of solid contents of the carboxyl-containing polyester resin (a) and epoxy resin (b).

In respect of corrosion resistance or low temperature-curability of coating film, it is particularly preferred to react a carboxyl-containing polyester resin (a) and an epoxy resin (b) at such ratios that the functional group ratio (aₘ/bₘ) between carboxyl group(s) (aₘ) in the carboxyl-containing polyester resin (a) to epoxy group(s) (bₘ) in the epoxy resin (b) should lie within a range greater than 1 but not greater than 10, in particular, 1.1-5, inter alia, 1.5-3. Here “functional group ratio” means the ratio between the total number of carboxyl groups in the all carboxyl-containing polyester resin (a) to be reacted and the total number of epoxy groups in the all epoxy resin (b) to be reacted. For example, when 2 mols of a carboxyl-containing polyester resin (a) having 2 carboxyl groups per mol is reacted with 1 mol of an epoxy resin (b) having 2 epoxy groups per mol, the total number of carboxyl group is 2×2=4 and that of epoxy group is 2×1=2, and the functional group ratio becomes 4/2=2.

The addition reaction can be normally conducted in a suitable solvent, at 80-170° C., preferably 90-150° C., for around 1-6 hours, preferably around 1-5 hours. As the solvent, for example, hydrocarbons such as toluene, xylene, cyclohexane, n-hexane and the like; ether alcohols such as ethylene glycol monomethyl ether, ethylene glycol monoethyl ether, ethylene glycol monobutyl ether, diethylene glycol monomethyl ether, diethylene glycol monoethyl ether, propylene glycol monomethyl ether, methoxymethanol and the like; ketones such as acetone, methyl ethyl ketone, methyl isobutyl ketone, methyl amyl ketone and the like; amides such as dimethylformamide, dimethylacetamide and the like; alcohols such as methanol, ethanol, n-propanol, i-propanol and the like; or mixtures of the foregoing can be used.

Thus obtained epoxy resin-modified polyester resin (A1) can generally have a number-average molecular weight ^{(note 1)}within a range of 1,000-100,000, preferably 1,500-20,000, inter alia, 2,000-5,000; an acid value within a range of 1-200 mgKOH/g, preferably 10-100 mgKOH/g, inter alia, 15-60 mgKOH/g; and a hydroxyl value within a range of 10-500 mgKOH/g, preferably 40-200 mgKOH/g, inter alia, 50-150 mgKOH/g.

Epoxy Resin-Modified Polyester Resin (A2):

The epoxy resin-modified polyester resin (A2) which is useful in the anionic electrodeposition paint of the present invention is a resin formed by reacting a carboxyl-containing polyester resin (a) with an epoxy resin (b) having at least one epoxy group per molecule and at least one active hydrogen compound (c) selected from monophenols, monoalcohols and aliphatic monocarboxylic acids.

As the above carboxyl-containing polyester resin (a) and the epoxy resin (b) having at least one epoxy group per molecule, those similar to the carboxyl-containing polyester resin (a) and the epoxy resin (b) having at least one epoxy group per molecule as described in connection with preparation of epoxy resin-modified polyester resin (A1) can be used.

Active Hydrogen Compound (c):

The active hydrogen compound (c) is a compound having at least one active hydrogen reactable with epoxy group, per molecule, and is selected from monophenols, aliphatic monocarboxylic acids and monoalcohols.

Specific examples of the monophenols include phenol, cresol, ethylphenol, para-tert-butylphenol, nonylphenol and the like, nonylphenol being particularly preferred.

As the aliphatic monocarboxylic acids, for example, acetic acid, propionic acid, butyric acid, valeric acid, acrylic acid, oleic acid, glycolic acid, glyceric acid, lactic acid, dimethylolpropionic acid, dimethylolbutyric acid, dimethylolvaleric acid, benzoic acid, gallic acid and the like can be named. Of these, acetic acid, propionic acid, butyric acid, oleic acid, dimethylolpropionic acid, dimethylolbutyric acid, dimethylolvaleric acid and benzoic acid are preferred, dimethylolbutyric acid being the most preferred.

An specific examples of the monoalcohols, methyl alcohol, ethyl alcohol, n-propyl alcohol, i-propyl alcohol, n-butyl alcohol, i-butyl alcohol, 2-ethylbutanol and 2-ethylhexanol can be named. Of these, 2-ethylhexanol is particularly preferred.

As epoxy resin-modified polyester resin (A2) can be prepared by addition reaction of an epoxy resin (b) having at least one epoxy group per molecule and an active hydrogen compound (c) to above-described carboxyl-containing polyester resin (a) by a means known per se. The order of reactions in that occasion is not critical, but it is normally convenient to cause reaction of the epoxy resin (b) with the active hydrogen compound (c) and then to react the residual epoxy groups in the epoxy resin (b) with the carboxyl-containing polyester resin (a).

The reaction ratios of the epoxy resin (b) and the active hydrogen compound (c) to the carboxyl-containing polyester resin (a) are not strictly limited but are adequately variable depending on the intended utility of anionic electrodeposition paint. Whereas, in general terms it is preferred to use the carboxyl-containing polyester resin (a) within a range of 50-85 mass %, in particular, 50-80 mass %, inter alia, 55-75 mass %; the epoxy resin (b), within a range of 5-49 mass %, in particular, 6-43 mass %, inter alia, 10-35 mass %; and the active hydrogen compound (c), within a range of 1-25 mass %, in particular, 6-20 mass %, inter alia, 6-10 mass %, based on the combined mass of the solid contents of the carboxyl-containing polyester resin (a), epoxy resin (b) and active hydrogen compound (c).

From the standpoint of dispersibility of the resin and corrosion resistance of the coating film, it is particularly preferred to react the carboxyl-containing polyester resin (a), epoxy resin (b) and active hydrogen compound (c) at such ratios that the functional group ratio [(aₘ+cₘ)/bₘ] between the sum of carboxyl groups (aₘ) in the carboxyl-containing polyester resin (a) and active hydrogen (cₘ) in the active hydrogen compound (c), (aₘ+cₘ), to the epoxy groups (bₘ) in the epoxy resin (b), becomes greater than 1 but not greater than 10, in particular, 1.1-5, inter alia, 1.5-3. Here “functional group ratio” is the same as defined previously.

The addition reaction can be normally conducted in a suitable solvent, at 80-170° C., preferably 90-150° C., for around 1-6 hours, preferably around 1-5 hours. As the solvent, for example, hydrocarbons such as toluene, xylene, cyclohexane, n-hexane and the like; ether alcohols such as ethylene glycol monomethyl ether, ethylene glycol monoethyl ether, ethylene glycol monobutyl ether, diethylene glycol monomethyl ether, diethylene glycol monoethyl ether, propylene glycol monomethyl ether, methoxymethanol and the like; ketones such as acetone, methyl ethyl ketone, methyl isobutyl ketone, methyl amyl ketone and the like; amides such as dimethylformamide, dimethylacetamide and the like; alcohols such as methanol, ethanol, n-propanol, i-propanol and the like; or mixtures of the foregoing can be used.

Thus obtained epoxy resin-modified polyester resin (A2) can generally have a number-average molecular weight (note 1) within a range of 1,000-100,000, preferably 1,500-20,000, inter alia, 2,000-5,000; an acid value within a range of 1-200 mgKOH/g, preferably 10-100 mgKOH/g, inter alia, 15-60 mgKOH/g; and a hydroxyl value within a range of 10-500 mgKOH/g, preferably 40-200 mgKOH/g, inter alia, 50-150 mgKOH/g.

Anionic Electrodeposition Paint:

The anionic electrodeposition paint which is provided by the present invention contains an epoxy resin-modified polyester resin (A1) and/or epoxy resin-modified polyester resin (A2) prepared as above as its base resin, and can be made a heat-curable anionic electrodeposition paint when used in combination with a crosslinking agent (B).

Crosslinking Agent (B):

As the crosslinking agent (B), for example, melamine resin, blocked polyisocyanate compound and the like are preferred from the standpoint of favorable coating film performance.

As the melamine resin, for example, methylolated melamine resin formed by methylolating melamine with formaldehyde; alkylated melamine resin formed by etherifying the methylol groups with monohydric alcohol; methylolated or alkylated melamine resin having imino groups; and the like can be named. Mixed alkylated-melamine resin obtained by using two or more monohydric alcohols in the occasion of etherifying the methylol groups can also be used. As useful monohydric alcohol, for example, methyl alcohol, ethyl alcohol, n-propyl alcohol, i-propyl alcohol, n-butyl alcohol, i-butyl alcohol, 2-ethylbutanol, 2-ethylhexanol and the like can be named.

As specific melamine resins, for example, methylated melamine resin, imino-containing methylated melamine resin, methylated-butylated melamine resin, imino-containing methylated-butylated melamine resin and the like can be named, methylated melamine resin and methylated-butylated melamine resin being particularly preferred.

As commercially available products of these melamine resins, for example, Cymel 202, Cymel 232, Cymel 235, Cymel 238, Cymel 254, Cymel 266, Cymel 267, Cymel 272, Cymel 285, Cymel 301, Cymel 303, Cymel 325, Cymel 327, Cymel 350, Cymel 370, Cymel 701, Cymel 703, Cymel 736, Cymel 738, Cymel 771, Cymel 1141, Cymel 1156, Cymel 1158, and the like (tradename, Nihon Cytec Industries, Inc., Ltd.); U-Van 120, U-Van 20HS, U-Van 2021, U-Van 2028, U-Van 2061 and the like (tradename, Mitsui Chemicals, Inc.); Melan 522 and the like (tradename: Hitachi Chemical) and the like, can be named.

Blocked polyisocyanate compound is a polyisocyanate compound whose isocyanate groups are partially or completely blocked with a blocking agent. As the polyisocyanate compound, those known per se can be used, for example, aromatic, aliphatic or alicyclic polyisocyanate compounds such as tolylene diisocyanate, xylylene diisocyanate, phenylene diisocyanate, diphenylmethane-2,4′-diisocyanate, diphenylmethane-4,4′-diisocyanate (normally referred to as “MDI”), crude MDI, bis(isocyanatomethyl)cyclohexane, tetramethylene diisocyanate, hexamethylene diisocyanate, methylene diisocyanate, isophorone diisocyanate and the like; cyclized polymers and isocyanate biuret bodies of these polyisocyanate compounds; and end isocyanate-containing compounds obtained by reacting excessive amounts of these polyisocyanate compounds with low molecular weight active hydrogen-containing compounds such as ethylene glycol, propylene glycol, trimethylolpropane, hexanetriol, castor oil and the like. These can be used either singly or in combination of two or more.

Blocking agent adds to isocyanate group(s) in such polyisocyanate compound to block the same. The blocked polyisonate compound formed upon the addition preferably is such that it is stable at normal temperature but when heated to baking temperature of coating film (normally about 100-about 200° C.), the blocking agent is dissociated therefrom to regenerate free isocyanate group(s).

As the blocking agent satisfying such a requirement, for example, lactam compound such as ε-caprolactam, γ-butyrolactam and the like; oxime compound such as methyl ethyl ketoxime, cyclohexanone oxime and the like; phenol compound such as phenol, para-t-butylphenol, cresol and the like; aliphatic alcohol such as n-butanol, 2-ethylhexanol and the like; aromatic alkyl alcohols such as phenyl carbinol, methylphenyl carbinol and the like; and ether alcohol compound such as ethylene glycol monobutyl ether, diethylene glycol monoethyl ether and the like can be named.

The blend ratio of such crosslinking agent (B) to the epoxy resin-modified polyester resin (A1) and/or epoxy resin-modified polyester resin (A2) is not strictly limited but can be suitably varied depending on the coating film performance required in individual occasion. Whereas, in general terms, the epoxy resin-modified polyester rein (A1) and/or epoxy resin-modified polyester resin (A2) can be within a range of 50-85 mass %, preferably 55-80 mass %, inter alia, 55-78 mass %; and the crosslinking agent (B), generally within a range of 15-50 mass %, preferably 20-45 mass %, inter alia, 22-45 mass %, based on the combined mass of solid contents of the epoxy resin-modified polyester resin (A1) and/or epoxy resin-modified polyester resin (A2) and the crosslinking agent (B).

The anionic electrodeposition paint comprising above epoxy resin-modified polyester resin (A1) and/or epoxy resin-modified polyester resin (A2) and crosslinking agent (B) can be formulated by thoroughly mixing the epoxy resin-modified polyester resin (A1) and/or epoxy resin-modified polyester resin (A2) and crosslinking agent (B), and neutralizing the mixture with a basic compound, normally in an aqueous medium, to make the epoxy resin-modified polyester resin (A1) and/or epoxy resin-modified polyester resin (A2) water-soluble or water-dispersible.

As the basic compound useful for the neutralization, for example, hydroxides of alkali metals or alkaline earth metals such as sodium hydroxide, potassium hydroxide, lithium hydroxide, calcium hydroxide, barium hydroxide and the like; ammonia; primary monoamines such as ethylamine, propylamine, butylamine, benzylamine, monoethanolamine, neopentanolamine, 2-aminopropanol, 3-aminopropanol and the like; secondary monoamines such as diethylamine, diethanolamine, di-n- or di-1-propanolamine, N-methylethanolamine, N-ethylethanolamine and the like; tertiary monoamines such as dimethylethanolamine, trimethylamine, triethylamine, triisopropylamine, methyldiethanolamine, dimethylaminoethanol and the like; and polyamines such as diethylenetriamine, hydroxyethylaminoethylamine, ethylaminoethylamine, methylamino-propylamine and the like can be named. It is normally preferred to use these basic compounds within a range of 0.1-1 equivalent, in particular, 0.4-0.8 equivalent, to the carboxyl groups in the epoxy resin-modified polyester resin (A1) and/or epoxy resin-modified polyester resin (A2), from the standpoint of paint stability.

Furthermore, where necessary, the anionic electrodeposition paint according to the present invention can suitably contain coloring pigment such as titanium white, carbon black and the like; extender such as clay, talc, baryta and the like; rustproofing agent such as aluminium dihydrogen tripolyphosphate, phosphomolybdic acid, bismuth oxide, bismuth hydroxide, basic bismuth carbonate, bismuth nitrate, bismuth silicate and the like; organic solvent such as acetone, methyl isobutyl ketone and the like; pigment dispersing agent, surface regulating agent and the like.

Furthermore, for accelerating the crosslinking reaction of coating film, sulfonic acid compound may also be added. As the sulfonic acid compound, for example, n-butylbenzenesulfonic acid, n-amylbenzenesulfonic acid, n-octylbenzenesulfonic acid, n-dodecylbenzenesulfonic acid, n-octadecylbenzenesulfonic acid, n-dibutylbenzenesulfonic acid, i-propylnaphthalenesulfonic acid, dodecylnaphthalenesulfonic acid, dinonylnaphthalenesulfonic acid, dinonylnaphthalenedisulfonic acid and the like can be named. Of these, use of n-dodecylbenzenesulfonic acid which exhibits particularly favorable effect is preferred.

The content of such sulfonic acid compound in the anionic electrodeposition paint of the present invention is not strictly limited but is variable over a wide range depending on the performance required for the paint. Whereas, in general terms the convenient range is 0.01-10 mass parts, preferably 0.03-5.0 mass parts, per 100 mass parts of combined solid contents of the epoxy resin-modified polyester resin (A1) and/or epoxy resin-modified polyester resin (A2) and the crosslinking agent (B).

The anionic electrodeposition paint of the present invention can be electrocoated on any desired electrically conductive substrate surface. The electrocoating can be normally conducted by using an electrodeposition bath formed of an anionic electrodeposition paint which is diluted with deionized water or the like to a solid concentration of from about 5 to 40 mass %, preferably 10-25 mass %, and adjusted of its pH within a range of 7-10, normally under the conditions of the bath temperature ranging 10-35° C. and applied voltage of 100-400 V, the object to be coated serving as the anode.

The thickness of the electrodeposited coating film is not particularly limited, but normally preferred range is 10-40 μm, in particular 15-35 μm, in terms of cured film thickness. Suitable baking temperature of the coating film is generally within a range of from 120 to 200° C., preferably from 130 to 170° C., at the substrate surface, and the baking time can be around 5-60 minutes, preferably around 10-30 minutes.

The anionic electrodeposition paint of the invention is conveniently used for utilities of electrodeposition paint in general but not limited thereto and can be used as waterborne paint to serve as anticorrosive primer in electrostatic coating, spray coating, roll coating or the like. It can also be used as two package type air-drying paint or adhesive which use polyisocyanate compound as the crosslinking agent.

### EXAMPLES

Hereinafter the invention is explained more specifically, referring to working Examples, it being understood that the invention is not limited to these Examples only. In the Examples, “part” and “%” are mass part and mass %.

### Production Example 1

### Preparation of Polyester Resin (a₁)

A reactor equipped with a heater, stirrer, nitrogen inlet tube and fractionating column was charged with 550 parts of hexahydrophthalic anhydride, 160 parts of adipic acid, 220 parts of trimethylolpropane, 170 parts of neopentyl glycol and 350 parts of 2-butyl-2-ethyl-1,3-propanediol. Heating was started under dry nitrogen and the temperature was gradually raised to 230° C. The esterification reaction was conducted while the temperature was maintained at 230° C., until the acid value of the resin was lowered to not higher than 1 mgKOH/g. The system was cooled to 170° C. and further 160 parts of trimellitic anhydride was added, to provide a polyester resin (a₁) having an acid value of 60 mgKOH/g, hydroxyl value of 90 mgKOH/g, number-average molecular weight of 1,500 and solid resin content of 100 mass %.

### Production Example 2

### Preparation of Epoxy Resin-Modified Polyester Resin No. 1

A flask equipped with a stirrer, thermometer, nitrogen inlet tube and reflux condenser was charged with 500 parts of EPICOAT 828EL (tradename, Japan Epoxy Resin Co., an epoxy resin, epoxy equivalent=190, molecular weight=350), 200 parts of bisphenol A and 0.1 part of dimethylbenzylamine, which were then reacted at 130° C. until the epoxy equivalent rose to 750.

Successively 1,500 parts of the polyester resin (a₁) having a solid resin content of 100 mass % as obtained in Production Example 1 was added and reacted at 130° C. for 4 hours. Thereafter adding 550 parts of ethylene glycol monobutyl ether, an epoxy resin-modified polyester resin No. 1 having an acid value of 34 mgKOH/g, hydroxyl value of 60 mgKOH/g and solid resin content of 80% was obtained.

### Production Example 3

### Preparation of Polyester Resin (a₂)

A reactor equipped with a heater, stirrer, nitrogen inlet tube and fractionating column was charged with 360 parts of hexahydrophthalic anhydride, 300 parts of adipic acid, 220 parts of trimethylolpropane and 580 parts of 2-butyl-2-ethyl-1,3-propanediol. Heating was started under dry nitrogen and the temperature was gradually raised to 230° C. The esterification reaction was conducted while maintaining the temperature of 230° C., until the acid value of the resin dropped to not higher than 1 mgKOH/g. The system was cooled to 170° C. and further 160 parts of trimellitic anhydride was added, to provide a polyester resin (a₂) having an acid value of 65 mgKOH/g, hydroxyl value of 90 mgKOH/g, number-average molecular weight of 1,800 and solid resin content of 100 mass %.

### Production Example 4

### Preparation of Epoxy Resin-Modified Polyester Resin No. 2

A flask equipped with a stirrer, thermometer, nitrogen inlet tube and reflux condenser was charged with 259 parts of EPICOAT 828EL, into which 29 parts of bisphenol A and 0.1 part of dimethylbenzylamine were added and reacted at 120° C. until the epoxy equivalent rose to 250. Then 107 parts of ε-caprolactone and 0.02 parts of tetrabutoxytitanium were added and the temperature was raised to 170° C. While maintaining said temperature, sampling was conducted with time, and at the point of time the convention reached 98% or higher as determined by tracing the amount of unreacted ε-caprolactone by infrared ray spectroscopic analysis, 74 parts of bisphenol A and 0.2 part of dimethylbenzylamine were further added. The reaction was continued at 130° C., until the epoxy equivalent rose to 936.

Successively 1,500 parts of the polyester resin (a₂) having a solid resin content of 100 mass % as obtained in Production Example 3 was added and reacted at 130° C. for 4 hours. Thereafter adding 490 parts of ethylene glycol monobutyl ether, an epoxy resin-modified polyester resin No. 2 having an acid value of 30 mgKOH/g, hydroxyl value of 80 mgKOH/g and solid resin content of 80% was obtained.

### Production Example 5

### Preparation of Polyester Resin (a₃)

A reactor equipped with a heater, stirrer, nitroden inlet tube and fractionating column was charged with 850 parts of hexahydrophthalic anhydride, 110 parts of adipic acid, 320 parts of trimethylolpropane, 330 parts of neopentyl glycol and 380 parts of 2-butyl-2-ethyl-1,3-propanediol. Heating was started under dry nitrogen and the temperature was gradually raised to 230° C. The esterification reaction was conducted while the temperature was maintained at 230° C., until the acid value of the resin was lowered to not higher than 1 mgKOH/g. The system was cooled to 170° C. and further 230 parts of trimellitic anhydride was added, to provide a polyester resin (a₃) having an acid value of 65 mgKOH/g, hydroxyl value of 120 mgKOH/g, number-average molecular weight of 1,300 and solid resin content of 100 mass %.

### Production Example 6

### Preparation of Epoxy Resin-Modified Polyester Resin No. 3

To 500 parts of EPICOAT 828EL (tradename, Japan Epoxy Resin Co., an epoxy resin, epoxy equivalent=190, molecular weight=350), 200 parts of bisphenol A and 0.1 part of dimethylbenzylamine were added and reacted at 130° C. until the epoxy equivalent rose to 750. Then 55 parts of nonyl phenol and 2,100 parts of the polyester resin (a₃) having a solid resin content of 100 mass % as obtained in Production Example 5 were added and reacted at 130° C. for 4 hours, followed by addition of 710 parts of ethylene glycol monobutyl ether. Thus an epoxy resin-modified polyester resin No. 3 having an acid value of 30 mgKOH/g, hydroxyl value of 80 mgKOH/g and solid resin content of 80% was obtained.

### Production Example 7

### Preparation of Epoxy Resin-Modified Polyester Resin No. 4

To 500 parts of EPICOAT 828EL (tradename, Japan Epoxy Resin Co., an epoxy resin, epoxy equivalent=190, molecular weight=350), 200 parts of bisphenol A and 0.1 part of dimethylbenzylamine were added and reacted at 130° C. until the epoxy equivalent rose to 750. Then 37 parts of dimethylolbutyric acid and 2,100 parts of the polyester resin (a₃) as obtained in Production Example 5 were added and reacted at 130° C. for 4 hours, followed by addition of 710 parts of ethylene glycol monobutyl ether. Thus an epoxy resin-modified polyester resin No. 4 having an acid value of 30 mgKOH/g, hydroxyl value of 80 mgKOH/g and solid resin content of 80% was obtained.

### Production Example 8

### Preparation of Epoxy Resin-Modified Polybutadiene Resin

To 270 parts of an esterification product of an epoxy resin, which had been prepared by reacting 325 parts of EPICOAT 1001 (tradename, Japan Epoxy Resin Co., an epoxy resin, epoxy equivalent=475, molecular weight=900) with 525 parts of linseed oil fatty acid and 175 parts of dehydrated castor oil fatty acid, 140 parts of poly(1,2-butadienecarboxylic acid) (NISSO-PBC-1,000, Nippon Soda Co. Ltd.), 40 parts of 1,4-butadiene and 75 parts of maleic anhydride were added and reacted at 200° C. Then the anhydride group was ring-opened and 131 parts of ethylene glycol monobutyl ether was added to provide an epoxy resin-modified polybutadiene resin having an acid value of 85 mgKOH/g and solid resin content of 80%.

### Production Example 9

### Preparation of Acrylic Resin

Into 55 parts of isopropyl alcohol maintained at 80° C., a mixture of 15 parts of styrene, 38 parts of methyl methacrylate, 15 parts of n-butyl acrylate, 10 parts of ethyl acrylate, 15 parts of 2-hydroxyethyl acrylate, 7 parts of acrylic acid and 7 parts of azobisdimethylvaleronitrile was dropped over 3 hours, and the system was maintained at the same temperature for the following an hour. Then 1 part of azobisdimethylvaleronitrile and 13 parts of ethylene glycol monobutyl ether were dropped, followed by further 4 hours' reaction at 80° C. Thus an acrylic resin having an acid value of 55 mgKOH/g, hydroxyl value of 73 mgKOH/g, number-average molecular weight of 6,000 and solid resin content of 59% was obtained.

### Production Example 10

### Preparation of Blocked Polyisocyanate Curing Agent

To 270 parts of COSMONATE M-200 (tradename, Mitsui Chemicals Inc., crude MDI), 46 parts of methyl isobutyl ketone was added and the temperature was raised to 70° C. Further 46 parts of diethylene glycol monoethyl ether was added and the temperature was raised to 70° C. Then 281 parts of diethylene glycol monoethyl ether was slowly added and the temperature was raised to 90° C. While maintaining this temperature, the reaction liquid was sampled with time to confirm absence of absorption by unreacted isocyanate on infrared ray spectroscopic analysis. Adjusting the amount of the solvent, a blocked polyisocyanate curing agent having a solid resin content of 80% was obtained.

### Production Example 11

### Preparation of Emulsion No. 1 for Anionic Electrodeposition Paint

To 87.5 parts (solid content: 70 parts) of the epoxy resin-modified polyester resin No. 1 having a solid resin content of 80% as obtained in Production Example 2, 30 parts of NIKALAC MX-430 (note 2) (solid content: 30 parts), 19 parts of triethylamine (corres. to 0.4 equivalent) and 176 parts of deionized water were added to make the resin water-dispersible, to provide an emulsion No. 1 having a solid content of 32% for anionic electrodeposition paint.
(Note 2) NIKALAC MX-430: tradename, Sanwa Chemical Co., a melamine resin, solid content=100%).

### Production Examples 12-18

Emulsion Nos. 2-8 for anionic electrodeposition paint were prepared in Production Examples 12-18, in the manner similar to Production Example 11. Their compositions were as shown in Table 1.

TABLE 1

| | Production | Production | Production | Production | Production | Production | Production | Production |
|---|---|---|---|---|---|---|---|---|
| | Example 11 | Example 12 | Example 13 | Example 14 | Example 15 | Example 16 | Example 17 | Example 18 |
| Emulsion | No. 1 | No. 2 | No. 3 | No. 4 | No. 5 | No. 6 | No. 7 | No. 8 |
| Epoxy resin-modified | 87.5 (70) | | | | 87.5 (70) | 87.5 (70) | | |
| polyester resin No. 1 | | | | | | | | |
| Epoxy resin-modified | | 87.5 (70) | | | | | | |
| polyester resin No. 2 | | | | | | | | |
| Epoxy resin-modified | | | 87.5 (70) | | | | | |
| polyester resin No. 3 | | | | | | | | |
| Epoxy resin-modified | | | | 87.5 (70) | | | | |
| polyester resin No. 4 | | | | | | | | |
| Epoxy resin-modified | | | | | | | 87.5 (70) | |
| polybutadiene resin | | | | | | | | |
| Acrylic resin (solid | | | | | | | | 118.6 (70) |
| resin content = 59%) | | | | | | | | |
| NIKALAK MX-430 | 30 (30) | 30 (30) | 30 (30) | 30 (30) | 30 (30) | 15 (15) | 30 (30) | 30 (30) |
| (note 2) | | | | | | | | |
| Blocked | | | | | | 18.8 (15) | | |
| polyisocyanate curing | | | | | | | | |
| agent (solid resin | | | | | | | | |
| content = 80%) | | | | | | | | |
| n-Dodecylbenzene- | | | | | 2.5 (1) | 2.5 (1) | | |
| sulfonic acid | | | | | | | | |
| Triethylamine | 19 | 19 | 19 | 19 | 19 | 19 | 19 | 19 |
| Deionized water | 176 | 176 | 176 | 176 | 176.6 | 172.8 | 176 | 144.9 |
| 32% Emulsion | 312.5 (100) | 312.5 (100) | 312.5 (100) | 312.5 (100) | 315.6 (100) | 315.6 (100) | 312.5 (100) | 312.5 (100) |

### Production Example 19

### Preparation of Acrylic Resin Solution for Dispersing Pigment

An ordinary acrylic resin reaction tank equipped with a stirrer, thermometer and reflux condenser was charged with 37 parts of ethylene glycol monobutyl ether, which was heated under agitation and maintained at 110° C. Into the reaction tank then a mixture of 10 parts of styrene, 35 parts of methyl methacrylate, 20 parts of 2-ethylhexyl methacrylate, 10 parts of 2-hydroxyethyl methacrylate, 40 parts of NF BISOMER S20W (note 3), 1 part of azobisisobutyro-nitrile and 5 parts of isobutyl alcohol was dropped over 3 hours. After completion of the dropping, the system was aged at 110° C. for 30 minutes, and further an additional catalytic liquid mixture composed of 20 parts of ethylene glycol monobutyl ether and 0.5 part of azobisisobutyronitrile was dropped over an hour, followed by an hour's aging at 110° C. Cooling the reaction liquid, an acrylic resin solution for dispersing pigment, having a solid resin content of 55%, was obtained.
(Note 3) NF BISOMER S20W: tradename, Daiichi Kogyo Seiyaku Co., a 50% water-diluted methoxypolyethylene glycol monomethacrylate having a molecular weight of about 2080.

### Production Example 20

### Preparation of Pigment Dispersion Paste No. 1

Dispersing 5.5 parts (solid content=3 parts) of the pigment-dispersing acrylic resin solution having a solid resin content of 55% as prepared in Production Example 19, 3 parts of CARBON MA-7 (note 4), 7 parts of HYDRIDE PXN (note 5), 2 parts of KW-840E (note 6) and 98 parts of deionized water in a ball mill for 20 hours, pigment dispersion paste No. 1 was obtained.
(Note 4) CARBON MA-7: tradename, Mitsubishi Kasei Corp., carbon black
(Note 5) HYDRIDE PXN: tradename, Georgia Kaolin Co., aluminium silicate
(Note 6) KW-840E: tradename, Tayca Co., aluminium dihydrogen tripolyphosphate

### Production Examples 21-23

### Preparation of Pigment-Dispersion Paste Nos. 2-4

Pigment dispersion paste Nos. 2-4 were prepared in the manner similar to the pigment dispersion paste No. 1 in Production Example 20. Their compositions were as shown in Table 2.

TABLE 2

| | | Production | Production | Production | Production |
|---|---|---|---|---|---|
| | | Example 20 | Example 21 | Example 22 | Example 23 |
| Pigment Dispersion Paste | | No. 1 | No. 2 | No. 3 | No. 4 |
| Pigment-dispersing | Pigment-dispersing acrylic resin | 5.5 (3) | | 5.5 (3) | |
| resin | solution having a solid content of | | | | |
| | 55%, as obtained in Production | | | | |
| | Example 19 | | | | |
| | Epoxy resin-modified polyester | | 3.75 (3) | | 3.75 (3) |
| | resin No. 1 having a solid content | | | | |
| | of 80%, as obtained in Production | | | | |
| | Example 2 | | | | |
| Neutralizer | Triethylamine | | 0.35 | | 0.35 |
| Coloring pigment | CARBON MA-7 (note 4) | 3 | 3 | 3 | 3 |
| Extender | HYDRIDE PXN (note 5) | 7 | 7 | 7 | 7 |
| Rust-proofing | KW-840W (note 6) | 2 | | | |
| component | bismuth hydroxide | | 2 | | |
| | Lead chromate | | | | 2 |

| | | | | |
|---|---|---|---|---|
| Deionized water | 9.8 | 11.2 | 8.1 | 11.2 |
| 55% Pigment dispersion paste | 27.3 (15) | 27.3 (15) | 23.6 (13) | 27.3 (15) |

### EXAMPLES AND COMPARATIVE EXAMPLES

### Example 1

To 312.5 parts (solid content-100 parts) of the emulsion No. 1 as obtained in Production Example 11, 27.3 parts (solid content=15 parts) of the pigment dispersion paste No. 1 and 235.2 parts of deionized water were added, to provide an anionic electrodeposition paint No. 1 having a solid content of 20%.

### Examples 2-8

Anionic electrodeposition paint Nos. 2-8 were prepared in the manner similar to Example 1. Their compositions were as shown in Table 3.

TABEL 3

| | | Example 1 | Example 2 | Example 3 | Example 4 | Example 5 | Example 6 | Example 7 | Example 8 |
|---|---|---|---|---|---|---|---|---|---|
| Anionic electrodeposition | | No. 1 | No. 2 | No. 3 | No. 4 | No. 5 | No. 6 | No. 7 | No. 8 |
| paint | | | | | | | | | |
| Composition | emulsion No. 1 | 312.5 (100) | | | | | | 312.5 (100) | |
| | emulsion No. 2 | | 312.5 (100) | | | | | | |
| | emulsion No. 3 | | | 312.5 (100) | | | | | |
| | emulsion No. 4 | | | | 312.5 (100) | | | | |
| | emulsion No. 5 | | | | | 315.6 (101) | | | |
| | emulsion No. 6 | | | | | | 315.6 (101) | | 315.6 (101) |
| | pigment dispersion | 27.3 (15) | 27.3 (15) | 27.3 (15) | 27.3 (15) | 27.3 (15) | 27.3 (15) | | |
| | paste No. 1 | | | | | | | | |
| | pigment dispersion | | | | | | | 27.3 (15) | |
| | paste No. 2 | | | | | | | | |
| | pigment dispersion | | | | | | | | 23.6 (13) |
| | paste No. 3 | | | | | | | | |
| | deionized water | 235.2 | 235.2 | 235.2 | 235.2 | 237.1 | 237.1 | 235.2 | 230.8 |
| | 20% bath | 575 (115) | 575 (115) | 575 (115) | 575 (115) | 580 (116) | 580 (116) | 575 (115) | 570 (114) |

### Comparative Examples 1-5

Anionic electrodeposition paint Nos. 9-13 of Comparative Examples 1-5 were prepared in the manner similar to Example 1. Their compositions were as shown in Table 4.

TABLE 4

| | | Comparative | Comparative | Comparative | Comparative | Comparative |
|---|---|---|---|---|---|---|
| | | Example 1 | Example 2 | Example 3 | Example 4 | Example 5 |
| Anionic electrodeposition | | No. 9 | No. 10 | No. 11 | No. 12 | No. 13 |
| paint | | | | | | |
| Composition | emulsion | 312.5 (100) | 312.5 (100) | 312.5 (100) | | |
| | No. 7 | | | | | |
| | emulsion | | | | 312.5 (100) | 312.5 (100) |
| | No. 8 | | | | | |
| | pigment | 27.3 (15) | | | 27.3 (15) | |
| | dispersion | | | | | |
| | paste No. 1 | | | | | |
| | pigment | | 23.6 (13) | | | 23.6 (13) |
| | dispersion | | | | | |
| | paste No. 3 | | | | | |
| | pigment | | | 27.3 (15) | | |
| | dispersion | | | | | |
| | paste No. 4 | | | | | |
| | deionized | 262.5 | 228.9 | 235.2 | 262.5 | 228.9 |
| | water | | | | | |
| | 20% bath | 575 (115) | 565 (113) | 575 (115) | 575 (115) | 565 (113) |

### Comparative Example 6

As Comparative Example 6, ELECRON # 7100 BLACK (note 7) was used.
(Note 7) ELECRON # 7100 BLACK: tradename, Kansai Paint Co., an anionic electrodeposition paint using an unsaturated resin obtained by reacting a polybutadiene/epoxy resini fatty acid ester/linseed oil mixture with maleic an hydride
   Coating Test

In each of those anionic electrodeposition paint compositions as obtained in above Examples and Comparative Examples, a 0.8×150×70 mm cold-rolled steel sheet which had been chemically treated with PALBOND #3020 (tradename, Nippon Parkerizing Co., a zinc phosphate treating agent) was immersed and its electrodeposition coating was conducted at 250 V for 3 minutes. Baking the coating film in an electric hot air dryer at 130° C. for 20 minutes, electrocoated film having a dry thickness of 20 μm was obtained. Results of the performance tests of the coated sheets were as shown in Tables 5 and 6.

TABLE 5

| | | Example 1 | Example 2 | Example 3 | Example 4 | Example 5 | Example 6 | Example 7 | Example 8 |
|---|---|---|---|---|---|---|---|---|---|
| Anionic electrodeposition paint | | No. 1 | No. 2 | No. 3 | No. 4 | No. 5 | No. 6 | No. 7 | No. 8 |
| Coating | corrosion resistance | ⊙ | ◯ | ⊙ | ◯ | ⊙ | ⊙ | ⊙ | ◯ |
| film performance | (note 8) | | | | | | | | |
| | impact resistance | 40 | 50 | 40 | 40 | 50 | 50 | 50 | 40 |
| | (note 9) | | | | | | | | |
| | weatherability | ◯ | ⊙ | ◯ | ⊙ | ⊙ | ◯ | ⊙ | ◯ |
| | (note 10) | | | | | | | | |
| | secondary sagging and | ◯ | ◯ | ◯ | ◯ | ◯ | ◯ | ◯ | ◯ |
| | foaming resistance | | | | | | | | |
| | (note 11) | | | | | | | | |
| | watermark resistance | ◯ | ◯ | ◯ | ◯ | ◯ | ◯ | ◯ | ◯ |
| | (note 12) | | | | | | | | |
| | finished appearance | ◯ | ◯ | ◯ | ◯ | ◯ | ◯ | ◯ | ◯ |
| | (note 13) | | | | | | | | |

TABLE 6

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Anionic electrodeposition paint | | No. 9 | No. 10 | No. 11 | No. 12 | No. 13 | No. 14 |
| Coating | corrosion resistance (note 8) | Δ | X | ◯ | Δ | X | Δ |
| film performance | impact resistance (note 9) | 30 | 10 | 30 | 30 | 10 | 30 |
| | weatherability (note 10) | ◯ | X | Δ | ◯ | ◯ | Δ |
| | secondary sagging and foaming | Δ | X | Δ | Δ | X | X |
| | resistance (note 11) | | | | | | |
| | watermark resistance (note 12) | Δ | X | Δ | Δ | X | X |
| | finished appearance (note 13) | Δ | Δ | Δ | Δ | Δ | ◯ |

Those performance tests were conducted by the following methods.

(Note 8) Corrosion Resistance:

Coating film on each test coated sheet was cross-cut with a knife to the depth reaching the substrate surface, and the test coated sheet was given a saline solution spray resistance test for 240 hours following JIS Z-2371. Corrosion resistance was evaluated by the following standard according to width of rust and blister development from the knife cuts:
⊙: the maximum width of rusting and blistering from the cuts was less than 2 mm (single side);
◯: the maximum width of rusting and blistering from the cuts was no less than 2 mm but less than 3 mm (single side);
Δ: the maximum width of rusting and blistering from the cuts was no less than 3 mm but less than 4 mm (single side);
X: the maximum width of rusting and blistering from the cuts was 4 mm or more (single side)
   (Note 9) Impact resistance: Each test sheet was placed in a thermo-hygrostat chamber of 20° C.±1 in temperature and 75±2% in humidity for 24 hours. Each prescribed size of an anvil and a striker were mounted on DuPont Impact Tester and each test sheet was inserted therebetween with its coated side up. A weight weighing 500 g was dropped on the striker, to determine the dropping height (cm) which exerted the impact on the coating film to cause cracks and peeling.
   (Note 10) Weatherability:

Accelerated weatherability test by the sunshine carbon arc lamp system as specified by JIS K-5400 9.8.1 was conducted to determine the time required for reducing 60° specular reflectivity (%) of the irradiated coated surface to less than 80%, according to JIS K-5400 7.6 (1990).
⊙: More than 400 hours were required before 60° specular reflectivity (%) broke 80% level.
◯: More than 150 hours but less than 400 hours were required before 60° specular reflectivity (%) broke 80% level.
Δ: More than 50 hours but less than 150 hours were required before 60° specular reflectivity (%) broke 80% level.
X: Less than 50 hours were required before 60° specular reflectivity (%) broke 80% level.
   (Note 11) Secondary Sagging and Foaming Resistance:

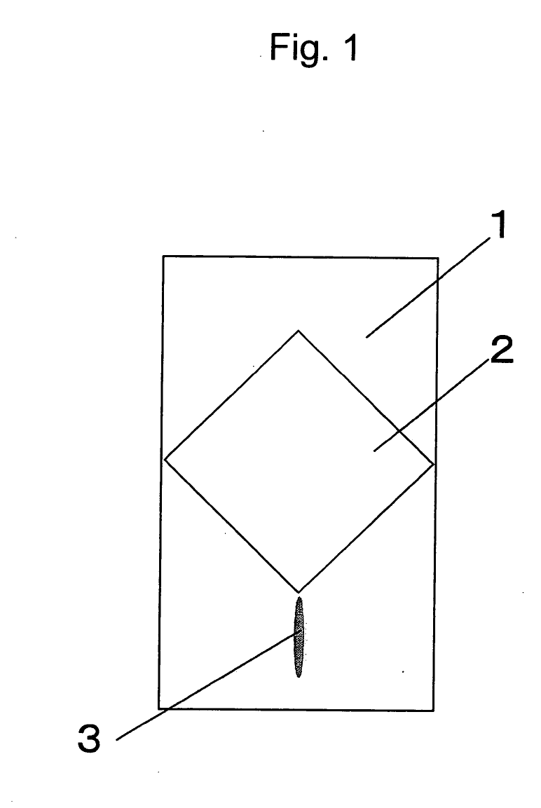

As shown in FIG. 1, two steel plates were put one upon another to form a jig (clearance=100 μm) which was electrocoated under the conditions as would provide a 20 μm-thick dry coating film, washed with water, set for 10 minutes and baked at 170° C. for 20 minutes. The secondary sagging and foaming condition of the coated surface was observed.
◯: good and free of any problem
Δ: adjustment by polishing or the like was necessary because of sagging and foaming
X: sagging and foaming markedly impaired appearance.
   (Note 12) Watermark Resistance:

Electrocoating was conducted under the conditions as would provide 20 μm-thick dry coating film, and the coated surface was washed with water and air-blown to almost water drop-free. Then 1 mL of a water drop (pure water) was dropped on the coated surface with a syringe. After 5 minutes' setting, the coated surface was baked and dried at 170° C. for 20 minutes.
◯: good and free of any problem
Δ: foaming or unevenness were observed on the coated surface
X: conspicuous foaming or unevenness were observed on the coated surface.
   (Note 13) Finished Appearance:

Electrocoating was conducted under the conditions as would provide 20 μm-thick dry coating film, and the coated surface was washed with water and bake-dried at 170° C. for 20 minutes. Foaming, dent and surface smoothness of the baked coating film were evaluated.
◯: good and free of any problem
Δ: either one of foaming, pinholes or deterioration in surface smoothness was observed.
X: either one of heavy foaming, pinholes or deterioration in surface smoothness was observed.

Use of above-described anionic electrodeposition paint of the present invention enables production of coated articles having coating film excelling in corrosion resistance, weatherablity, impact resistance, finished appearance, low temperature-curability, watermark resistance, coating workability and so on.

1. An anionic electrodeposition paint which comprises an epoxy resin-modified polyester resin (A1) which is prepared by reacting carboxyl-containing polyester resin (a) with epoxy resin (b) having at least one epoxy group per molecule.

2. An anionic electrodeposition paint which comprises an epoxy resin-modified polyeseter resin (A2) which is prepared by reacting carboxyl-containing polyester resin (a) with epoxy resin (b) having at least one epoxy group per molecule and at least one active hydrogen compound (c) selected from the group consisting of monophenols, aliphatic monocarboxylic acids and monoalcohols.

3. An anionic electrodeposition paint as set forth in claim 1 or 2, in which the carboxyl-containing polyester resin (a) has a number-average molecular weight within a range of 500-50,000 and an acid value within a range of 4-200 mgKOH/g.

4. An anionic electrodeposition paint as set forth in claim 1 or 2, in which the carboxyl-containing polyester resin (a) further contains hydroxyl groups and has a hydroxyl value within a range of 20-800 mgKOH/g.

5. An anionic electrodeposition paint as set forth in claim 1 or 2, in which the epoxy resin (b) is cyclic ester compound-modified epoxy resin (b1) which is prepared by addition reaction of cyclic ester compound to hydroxyl-containing epoxy resin.

6. An anionic electrodeposition paint as set forth in claim 1 or 2, in which the epoxy resin (b) has an epoxy equivalent within a range of 180-2,500 and a number-average molecular weight of at least 180.

7. An anionic electrodeposition paint as set forth in claim 1, in which the epoxy resin-modified polyester resin (A1) is prepared by reacting carboxyl-containing polyester resin (a) with epoxy resin (b) at a ratio of 50-85 mass % of the former and 15-50 mass % of the latter, based on the mass of combined solid contents of the carboxyl-containing polyester resin (a) and the epoxy resin (b).

8. An anionic electrodeposition paint as set forth in claim 1, in which the epoxy resin-modified polyester resin (A1) is prepared by reacting the carboxyl-containing polyester resin (a) and the epoxy resin (b) at such ratios that the functional group ratio (aₘ/bₘ) between carboxyl group(s) (aₘ) in the carboxyl-containing polyester resin (a) to epoxy group(s) (bₘ) in the epoxy resin (b) should lie within a range greater than 1 but not greater than 10.

9. An anionic electrodeposition paint as set forth in claim 1, in which the epoxy resin-modified polyester resin (A1) has a number-average molecular weight within a range of 1,000-100,000 and an acid value within a range of 1-200 mgKOH/g.

10. An anionic electrodeposition paint as set forth in claim 2, in which the epoxy resin-modified polyester resin (A2) is prepared by reacting the carboxyl-containing polyester resin (a) with the epoxy resin (b) and the active hydrogen compound (c) at the ratios of 50-85 mass %, 5-49 mass % and 1-25 mass %, respectively, based on the mass of combined solid content mass of the carboxyl-containing polyester resin (a), epoxy resin (b) and active hydrogen compound (c).

11. An anionic electrodeposition paint as set forth in claim 2, in which the epoxy resin-modified polyester resin (A2) is prepared by reacting carboxyl-containing polyester resin (a), epoxy resin (b) and active hydrogen compound (c) at such ratios that the functional group ratio [(aₘ+cₘ)/bₘ] of the sum of carboxyl groups (aₘ) in the carboxyl-containing polyester resin (a) and active hydrogen (cₘ) in the active hydrogen compound (c), (aₘ+cₘ), to the epoxy groups (bₘ) in the epoxy resin (b) becomes greater than 1 but not greater than 10.

12. An anionic electrodeposition paint as set forth in claim 2, in which the epoxy resin-modified polyester resin (A2) has a number-average molecular weight within a range of 1,000-100,000 and an acid value within a range of 1-200 mgKOH/g.

13. An anionic electrodeposition paint as set forth in claim 1 or 2, which further contains a crosslinking agent (B).

14. An anionic electrodeposition paint as set forth in claim 13, in which the crosslinking agent (B) is at least one crosslinking agent selected from the group consisting of melamine resin and blocked polyisocyanate compound.

15. An anionic electrodeposition paint as set forth in claim 13, which contains the epoxy resin-modified polyester resin (A1) or epoxy resin-modified polyester resin (A2) within a range of 50-85 mass %, and the crosslinking agent (B), within a range of 15-50 mass %, based on the mass of combined solid contents of the epoxy resin-modified polyester resin (A1) or epoxy resin-modified polyester resin (A2) and crosslinking agent (B).

16. Articles coated with an anionic electrodeposition paint as set forth in any one of claims 1 or 2.
